(19) United States
(12) Patent Application Publication
(10) Pub. No.: US 2007/0234429 A1
(43) Pub. Date: Oct. 4, 2007

(54) Image Forming Apparatus

(75) Inventor: Akihiro MIZUTANI, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/277,878

(22) Filed: Mar. 29, 2006

(51) Int. Cl. H04N 7/16

(52) U.S. Cl. 726/26

(57) ABSTRACT

An image forming apparatus performs authentication by using first identification information set for a user allowed to use. The apparatus counts a time in which the authentication has been continuously performed since a time when the authentication was performed. Then, the apparatus performs a previously determined processing, which corresponds to the counted time and the first identification information used for the authentication, for a private print job stored in a storage part and corresponding to the first identification information.

### BACKGROUND OF THE INVENTION

1. Field of the Invention

The present invention relates to an image forming apparatus having a private print function.

2. Description of the Related Art

In recent years, some image forming apparatuses as multi-function peripherals (MFP) are provided with authentication devices. The authentication devices include one that uses a non-contact IC card and one that uses biometrics. In the image forming apparatuses provided with such authentication devices, there is known one that can perform private printing by using the authentication device.

After a print job (private print job) for performing private printing is transmitted through, for example, a network from a PC, when the user performs the private printing by the image forming apparatus, there is a case where the user desires to change a print setting, to specify a print document, or to change the output format of a proof copy or the like. In such a case, it is required that after performing authentication, the user uses a control panel or the like provided in the image forming apparatus and performs an operation of changing the setting by manual input. This is a troublesome operation for the user.

### BRIEF SUMMARY OF THE INVENTION

An object of the invention is to provide an image forming apparatus in which when a private print job is processed, a processing format can be changed after authentication without performing an extra manual input operation.

According to an aspect of the invention, an image forming apparatus includes a first storage part configured to correlate first identification information set for a user allowed to use with second identification information of the user used in a network and to store them, a reception part configured to receive a private print job including the second identification information and information indicating print content through the network, an accumulation part configured to accumulate, for each piece of the second identification information, the private print job received in the reception part based on the information stored in the first storage part, a second storage part configured to store different processings for the accumulated private print jobs at intervals of previously set times and for each piece of the first identification information, a clock part configured to count a time, an authentication part configured to use the first identification information and to authenticate that the user is allowed to use, and a control part configured to use the clock part to count a time in which the authentication has been continuously performed since a time when the authentication was performed in the authentication part, and to perform a processing, which corresponds to the counted time and the first identification information used in the authentication and is stored in the second storage part, for the private print job accumulated in the accumulation part and corresponding to the first identification information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a control structure of an image forming apparatus of an embodiment and a network structure.

FIG. 2 is a table showing a relation between an employee number and a card ID stored in a card in the embodiment.

FIG. 3 is a table showing the setting of a processing and the setting of a message of the processing at the time of an authentication processing in the embodiment.

FIG. 4 is a table showing the setting of the processing for each card ID, which is made to correspond to an authentication continuation time in the embodiment.

FIG. 5 is another table showing the setting of the processing for each card ID, which is made to correspond to an authentication continuation time.

FIG. 6A shows the first half of a flowchart showing a processing executed by a CPU in the embodiment.

FIG. 6B shows the latter half of the flowchart showing the processing executed by the CPU in the embodiment.

FIG. 7 is a view showing a display example of a display part in the embodiment.

FIG. 8 is a view showing a display example of the display part in the embodiment.

FIG. 9 is a view showing a display example of the display part in the embodiment.

FIG. 10 is a view showing a display example of the display part in the embodiment.

FIG. 11 is a view showing a display example of the display part in the embodiment.

FIG. 12 is a view for explaining a flow in a private spooler in the embodiment.

### DETAILED DESCRIPTION OF THE INVENTION

Hereinafter, an embodiment of the invention will be described with reference to the drawings.

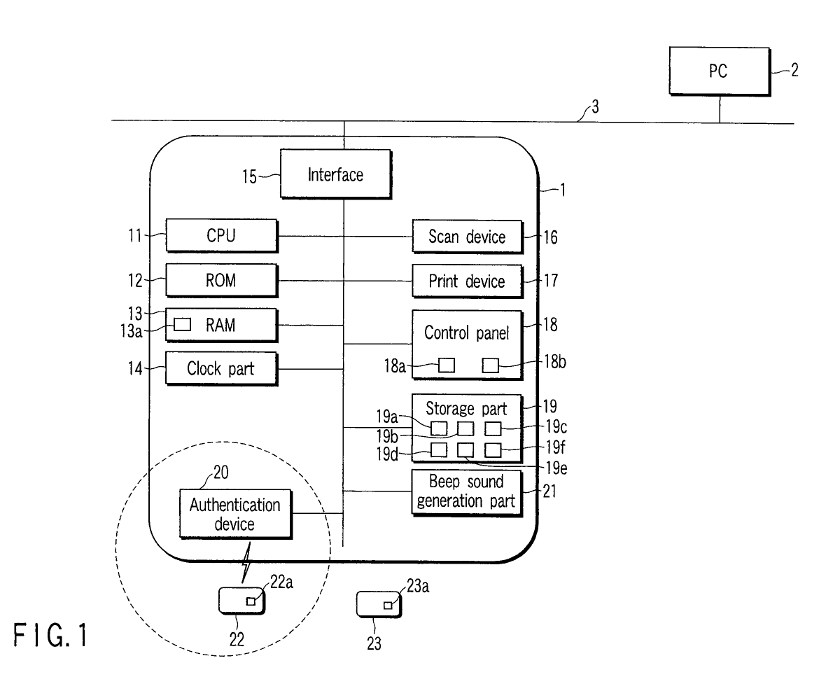

FIG. 1 is a block diagram showing a control structure of an image forming apparatus and a network structure. An image forming apparatus 1 and a PC 2 are connected to each other through a network 3.

A printer driver to cause the image forming apparatus 1 to perform printing through the network 3 is stored in the PC 2. The user uses the printer driver stored in the PC 2 and can transmit a private print job. At this time, the transmitted private print job includes information indicating a user name of the user of the PC 2 (in this embodiment, an employee number is assigned as the user name) and print content.

The image forming apparatus 1 includes a CPU 11, a ROM 12, a RAM 13, a clock part 14, an interface 15, a scan device 16, a print device 17, a control panel 18, a storage part 19, an authentication device 20, and a beep sound generation part 21.

The CPU 11 controls the entire image forming apparatus 1. The CPU 11 realizes various functions by executing control programs stored in the ROM 12 and control programs stored in the storage part 19. The ROM 12 is a nonvolatile memory in which a basic control program for the operation of the image forming apparatus 1, and the like are previously stored. The RAM 13 is a memory for temporarily storing working data and the like. The RAM 13 is provided with, for example, a start time storage part 13a to store a start time. The time when a card ID is authenticated by the authentication device 20 is stored in the start time storage part 13a. The clock part 14 generates present time information.

The interface 15 is for connection with the network 3. The image forming apparatus 1 receives a print job, such as a private print job, from the PC 2 through this interface 15.

The scan device 16 reads, for example, an image from a document placed on a not-shown document stand and generates image data.

The print device 17 performs printing based on the print job (including the private print job) received from the PC 2 through the network 3 or the image data generated by the scan device 16.

The control panel 18 includes an operation part 18a provided with various keys and buttons, and a touch panel 18b. The operation of the operation part 18a is performed by the user, or a button displayed on the touch panel 18b is inputted by the user, so that the instruction is transmitted to the CPU 11. Besides, various displays are carried out on the touch panel 18b based on the instruction from the CPU 11. For example, when the user performs private printing, a message indicating the content of the processing is displayed.

The storage part 19 is a hard disk drive including a magnetic disc and the like. The storage part 19 includes various tables, such as a first table 19a, a second table 19b and a third table 19c, a time storage part 19d, a spool part 19e and a control program storage part 19f. Incidentally, various control programs including a private print job processing control program, which will be described later, are stored in the control program storage part 19f.

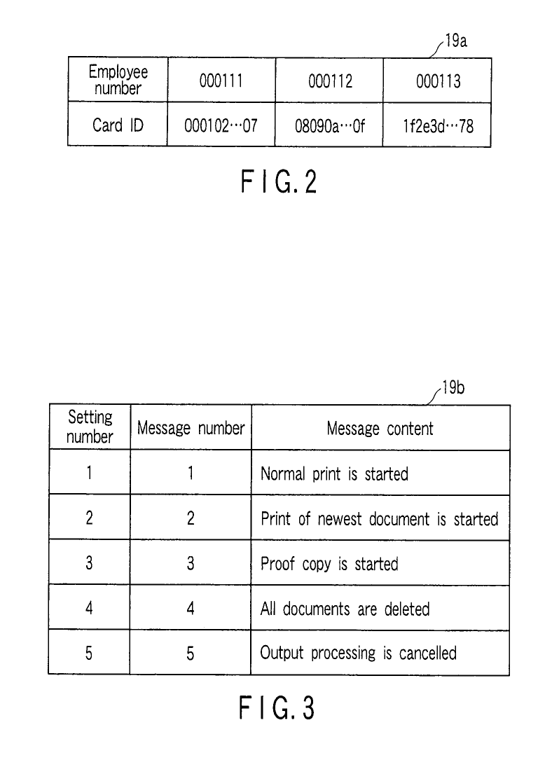

FIG. 2 is a view showing the first table 19a. As shown in FIG. 2, the first table 19a is a table showing a relation between an employee number and a card ID stored in a card. The employee number and the card ID are in one-to-one correspondence with each other. The employee number is used also as information to specify the user on the network 3. When the employee transmits the print job to the image forming apparatus 1 from the PC 2, the employee number is included as information to specify the employee in the print job.

FIG. 3 is a view showing the second table 19b. As shown in FIG. 3, the second table 19b is a table showing the setting of a processing of a private print job at the time of an authentication processing and the setting of a message of the processing. In the second table 19b, a setting number, a message number, and message content are correlated with one another. For example, the setting of a normal print is assigned to setting number 1, and the message “Normal print is started” of message number 1 is correlated therewith. Incidentally, the normal print here is such that when a card ID is recognized by the authentication device 20, all private print jobs stored correspondingly to the card ID are performed.

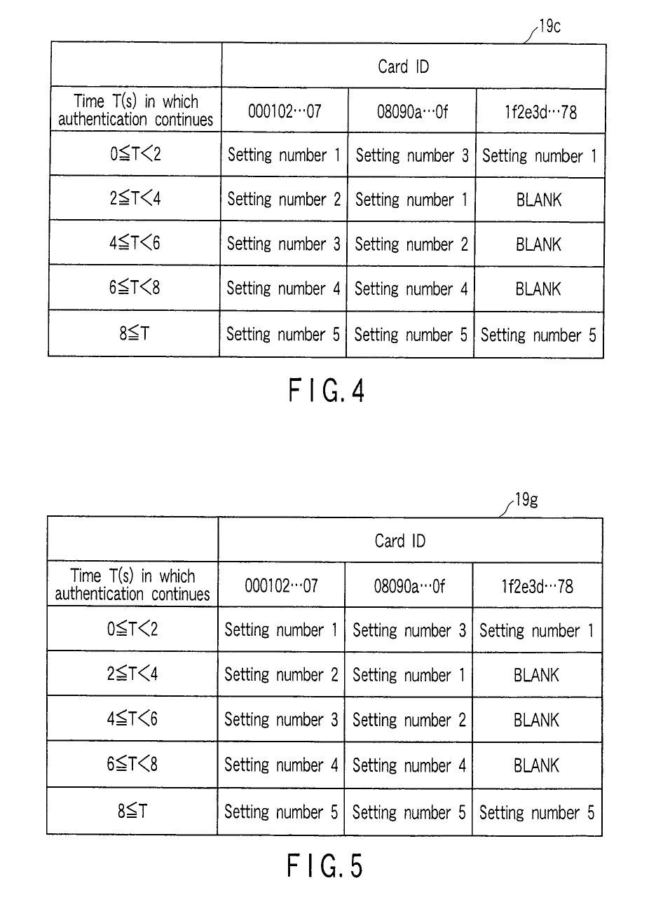

FIG. 4 is a view showing the third table 19c. As shown in FIG. 4, a processing method of a private print job corresponding to a time in which the authentication continues is set for each card ID. For example, for the card ID “000102 . . . 07”, a setting is made such that the processing of setting number 1 (normal print) is performed when a time T in which the authentication continues is less than 2 seconds, the processing of setting number 2 (print of newest document) is performed when the time T is not less than 2 seconds and less than 4 seconds, the processing of setting number 3 (proof copy) is performed when the time T is not less than 4 seconds and less than 6 seconds, the processing of setting number 4 (deletion of all documents) is performed when the time T is not less than 6 seconds and less than 8 seconds, and the processing of setting number 5 (cancel of operation) is performed when the time T is not less than 8 seconds. Incidentally, in this embodiment, the setting is made such that the setting of the processing method of the private print job varies for each card ID. Besides, for example, like an area corresponding to the card ID “1f2e3d . . . 78”, the setting of the print processing may not be performed for all the set time items.

Besides, in this embodiment, although the setting is made to keep a constant interval of 2 seconds, no limitation is made to this. For example, as shown in Table 19g of FIG. 5, the time interval may vary. That is, the setting may be made such that the first beep sound is generated when the authentication is started, the second beep sound is generated after 2 seconds, the third beep sound is generated when 3 seconds has passed since then, the fourth beep sound is generated when 4 seconds has passed since then, and the fifth beep sound is generated when 5 seconds has passed since then. That is, the time interval may be made long as time passes since the authentication was performed.

A time in which a beep sound is generated by the beep sound generation part 21 is stored in the time storage part 19d. In this embodiment, the beep sound is generated at intervals of 2 seconds since the authentication was performed in the authentication device 20. That is, 2 seconds are stored. Incidentally, in the case where the construction is made like the table 19g explained in FIG. 5, the setting time is stored in the time storage part 19d so that the respective times of 2 seconds, 3 seconds, 4 seconds and 5 seconds are set as stated above.

The spool part 19e spools the private print job received from the PC 2 through the network 3. A private spooler for each employee number is provided in the spool part 19e, and the private print job is spooled in the order of time series for each individual. As described above, the employee number is added to the private print. The CPU 11 uses this employee number and stores the received private print job into the spooler for each individual.

The authentication device 20 is a device for authenticating whether the user is allowed to use. In this embodiment, the authentication is performed according to whether the card ID acquired from the card corresponds to the employee number stored in the first table 19a of the storage part 19. When a card 22 owned by an employee is brought into the range of an electric wave emitted from the authentication device 20, information 22a indicating the card ID stored in the card 22 is read by the authentication device 20. The authentication device 20 judges whether the read information 22a indicating the card ID is stored in the first table 19a of the storage part 19. When it is stored, the card ID 22a continues to be read during a period when the card 22 is held in the range of the electric wave. Incidentally, like a card 23, in the outside of the range of the electric wave of the authentication device 20, information 23a indicating the card ID stored in the card 23 is not read. An authentication method may be another method. For example, an authentication method using biometrics may be adopted.

When the authentication device authenticates the card ID, or when the time stored in the time storage part 19d has passed since the authentication, the beep sound generation part 21 generates the beep sound based on the instruction of the CPU 11.

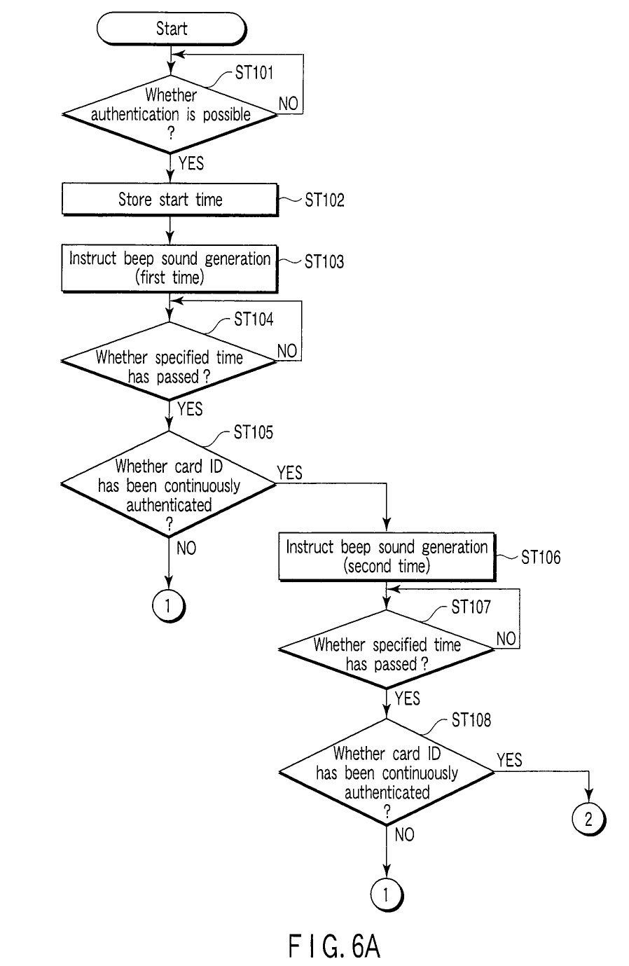

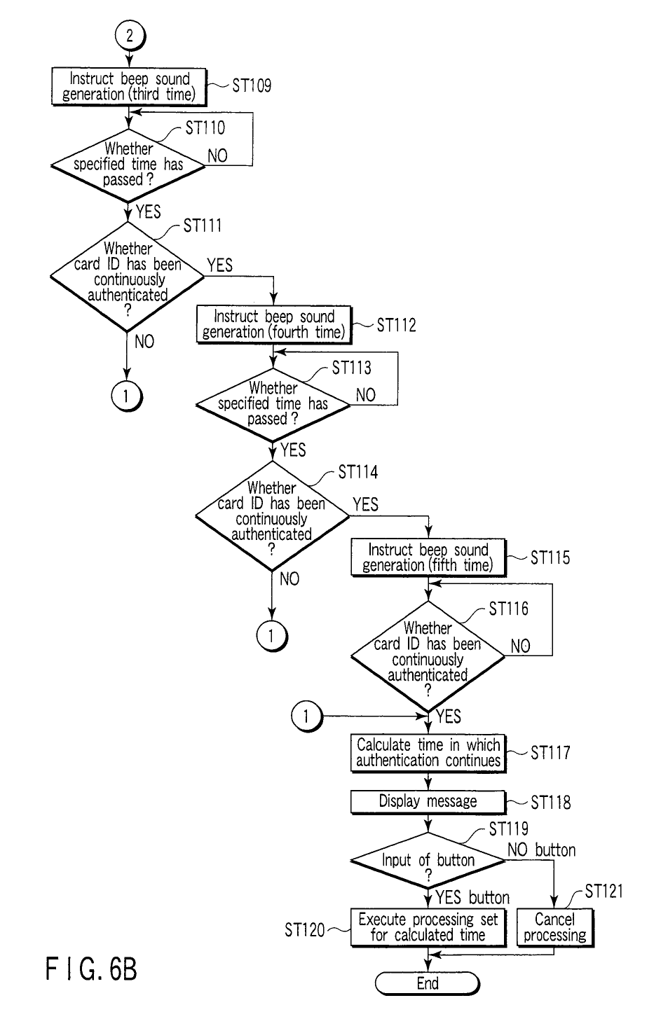

Next, a description will be given to a private print processing realized by the execution of a private print processing control program by the CPU 11. FIG. 6 is a flowchart showing the private print processing. Incidentally, FIG. 6A shows the first half of the processing, and FIG. 6B shows the latter half of the processing.

The CPU 11 judges whether authentication is possible (ST101). That is, information indicating a card ID stored in a card in the range of the electric wave emitted from the authentication device 20 is acquired, and it is judged based on the acquired information as to whether the card ID is the card ID stored in the first table 19a. When the card ID is stored in the first table 19a, the judgment is made that the authentication is possible, and when the card ID is not stored in the first table, the judgment is made that the authentication is impossible.

When the judgment is not made that the authentication is possible, the following processing is not performed (NO at ST101). That is, a standby state for card ID authentication continues. On the other hand, when the judgment is made that the authentication is possible (YES at ST101), the CPU 11 stores this time as the start time into the start time storage part 13a of the RAM 13 (ST102). Then, the CPU 11 issues an instruction of beep sound generation to the beep sound generation part 21 (ST103). By this, a beep sound is generated from the beep sound generation part 21. The user confirms the generation of the first beep sound by this sound.

Next, the CPU 11 judges whether a specified time has passed since the time stored as the start time (ST104). Incidentally, the specified time is 2 seconds as stored in the time storage part 19d in this embodiment.

When the CPU 11 judges that the specified time has passed (YES at ST104), a judgment is made whether the authenticated card ID has been continuously recognized (ST105). This judgment is made such that also after the authentication to the card, the electric wave for acquiring the card ID from the card is emitted, and the judgment is made based on whether the response electric wave continues to be received. When the CPU 11 judges that the card ID has not been continuously recognized (NO at ST105), advance is made to a processing of step ST117, which will be described later. That is, the case where advance is made to step ST117 is the case where the card is moved, in the specified time, to the outside of the range in which the electric wave emitted from the authentication device 20 arrives.

On the other hand, when the CPU 11 judges that the card ID has been continuously recognized (YES at ST105), the CPU 11 issues an instruction of beep sound generation to the beep sound generation part 21 (ST106). By this, a beep sound is generated from the beep sound generation part 21. The user confirms the generation of the second beep sound by this sound.

After this beep sound is caused to be generated (ST106), the CPU 11 judges whether 2 seconds as the specified time has passed since the generation of the second beep sound (ST107). That is, it is judged whether 4 seconds has passed since the start time stored in the start time storage part 13a. When the CPU 11 judges that the specified time has passed (YES at ST107), the CPU 11 judges whether the card ID has been continuously recognized (ST108). When the CPU 11 judges that the card ID has not been continuously recognized (NO at ST108), advance is made to the processing of step ST117, which will be described later.

On the other hand, when the CPU 11 judges that the card ID has been continuously recognized (YES at ST108), the CPU 11 issues an instruction of beep sound generation to the beep sound generation part 21 (ST109). By this, a beep sound is generated from the beep sound generation part 21. The user confirms the generation of the third beep sound by this sound.

After the beep sound is caused to be generated (ST109), the CPU 11 judges whether 2 seconds as the specified time have passed since the third beep sound was generated (ST110). That is, it is judged whether 6 seconds have passed since the start time stored in the start time storage part 13a. When the CPU 11 judges that the specified time has passed (YES at ST110), the CPU 11 judges whether the card ID has been continuously recognized (ST111). When the CPU 11 judges that the card ID has not been continuously recognized (NO at ST111), advance is made to the processing of step ST117, which will be described later.

On the other hand, when the CPU 11 judges that the card ID has been continuously recognized (YES at ST111), the CPU 11 issues an instruction of beep sound generation to the beep sound generation part 21 (ST112). By this, a beep sound is generated from the beep sound generation part 21. The user confirms the generation of the fourth beep sound by this sound.

After the beep sound is caused to be generated (ST112), the CPU 11 judges whether 2 seconds as the specified time have passed since the fourth beep sound was generated (ST113). That is, it is judged whether 8 seconds have passed since the start time stored in the RAM 13. When the CPU 11 judges that the predetermined time has passed (YES at ST113), the CPU 11 judges whether the card ID has been continuously recognized (ST114). When the CPU 11 judges that the card ID has not been continuously recognized (NO at ST114), advance is made to the processing of step ST117, which will be described later.

On the other hand, when the CPU 11 judges that the card ID has been continuously recognized (YES at ST114), the CPU 11 issues an instruction of beep sound generation to the beep sound generation part 21 (ST115). By this, a beep sound is generated from the beep sound generation part 21. The user confirms the generation of the fifth beep sound by this sound.

After the beep sound is caused to be generated (ST115), the CPU 11 judges whether the authenticated card ID has been continuously recognized (ST116). When the CPU 11 judges that card ID has not been continuously recognized (NO at ST105), advance is made to the processing of step ST117, which will be described later.

Next, a processing subsequent to step ST117 will be described. The CPU 11 calculates a time in which the card ID continues to be authenticated by the authentication device 20 (ST117). This time is calculated using the time acquired from the clock part 14 at this time and the start time stored in the start time storage part 13a. For example, a calculated time in the case (NO at step ST105) where the card was moved from the range of the electric wave of the authentication device 20 before 2 seconds as the specified time passes since the start time is less than 2 seconds.

When calculating the time in which the card ID continues to be authenticated as stated above (ST117), the CPU 11 performs a processing to display a message corresponding to this time on the touch panel 18b (ST118). That is, the message corresponding to the calculated time and the card ID is read from the second table 19b, and is displayed on the touch panel 18b. For example, in the case where the calculation time is less than 2 seconds, the message “Normal print is started” is displayed.

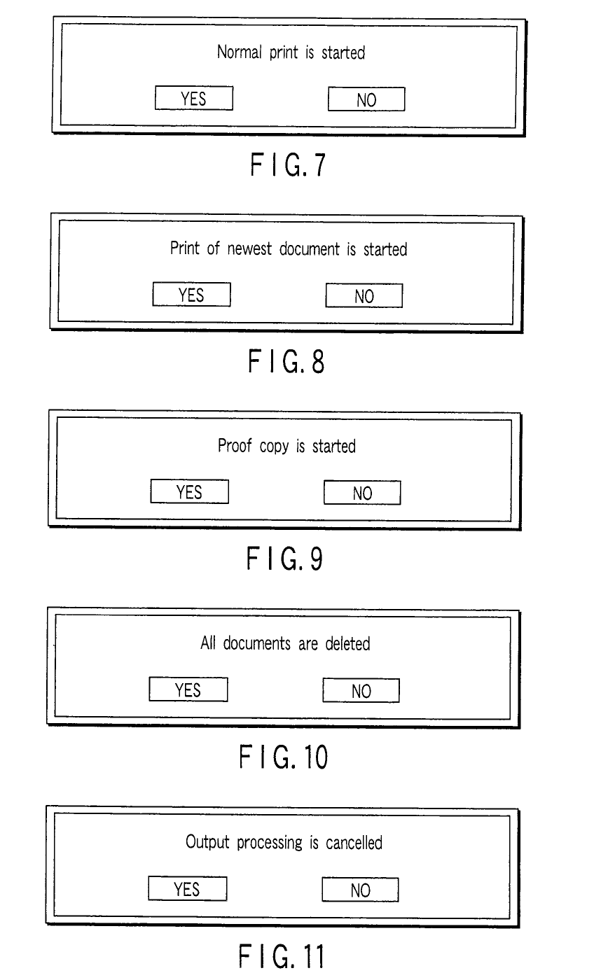

FIG. 7 to FIG. 11 are views showing display examples of messages for the respective times displayed on the touch panel 18b in the case of the member card “000102 . . . 07”. FIG. 7 is a view showing a display example of a message displayed when the calculation time is less than 2 seconds. The message “Normal print is started” corresponding to the calculation time is displayed. FIG. 8 is a view showing a display example of a message displayed when the calculation time is not less than 2 seconds and less than 4 seconds. The message “Print of newest document is started” corresponding to the calculation time is displayed. FIG. 9 is a view showing a display example of a message displayed when the calculation time is not less than 4 seconds and less than 6 seconds. The message “Proof copy is started” corresponding to the calculation time is displayed. FIG. 10 is a view showing a display example of a message displayed when the calculation time is not less than 6 seconds and less than 8 seconds. The message “All documents are deleted” corresponding to the calculation time is displayed. FIG. 11 is a view showing a display example of a message displayed when the calculation time is not less than 8 seconds. The message “Operation is cancelled” corresponding to the calculation time is displayed. Incidentally, when the message is displayed on the operation part 18a, as shown in FIGS. 7 to 11, “YES” and “NO” buttons are also displayed.

When the CPU 11 displays the message on the touch panel 18b (ST118), the CPU 11 judges which button is inputted (ST119). When the CPU 11 judges that the “YES” button is inputted (input of the YES button at ST119), the CPU 11 refers to the second table 19b, and executes the processing set to the setting number corresponding to the message displayed on the touch panel 18b (ST120). For example, in the case where “Normal print is started” is displayed on the touch panel 18b, the processing of the setting number 1 corresponding to the message is executed. Besides, when the CPU 11 judges that the “NO” button is inputted (input of the NO button at ST119), the CPU 11 cancels the authentication for the authenticated card ID (ST121).

Incidentally, in this embodiment, correspondingly to the time in which the ID card has been continuously recognized, the “YES” button and the “NO” button, together with the message, are displayed on the touch panel 18b. Then, the input of the “YES” button or the “NO” button is detected, and the processing is performed. However, only the message is displayed on the touch panel 18b, and the “YES” button and the “NO” button may not be displayed. In this case, when the message is displayed on the touch panel 18b, the processing of the private print job corresponding to the setting number is automatically performed.

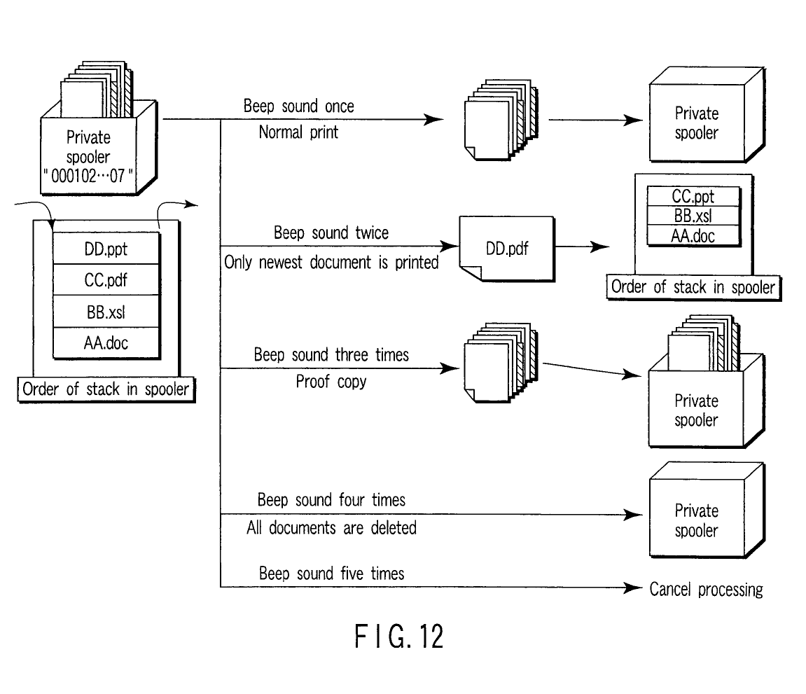

FIG. 12 is a view for explaining a processing of a private print job transmitted from the PC 2. Plural private print jobs are stored in a private spooler. Incidentally, the private print job is described in, for example, post script (PS). The order of stack of jobs in the private spooler is the order of new jobs. For example, as shown in FIG. 12, in the private spooler corresponding to the card ID “000102 . . . 07”, the jobs are arranged in the order of new jobs, such as “DD.pdf”, “CC.ppt”, “BB.xsl” and “AA.doc”. Accordingly, when the card in which the card ID is stored enters the range of the electric wave of the authentication device 20 and is moved to the outside of the range of the electric wave in 2 seconds, that is, when the beep sound is generated once, the processing of the private print becomes the normal print. Accordingly, all the jobs in the private spooler are executed and the private spooler becomes empty. Besides, when the card is in the range of the electric wave until 4 seconds have passed, and then is moved to the outside of the range of the electric wave, that is, when the beep sound is generated twice, the processing of the private print becomes the print of only the newest document. Accordingly, only “DD.pdf” is printed, and the three jobs of “CC.ppt”, “BB.xsl” and “AA.doc” remain to be stored in the private spooler. Besides, when the card is in the range of the electric wave until 6 seconds have passed, and then is moved to the outside of the range of the electric wave, that is, when the beep sound is generated three times, the processing of the private print job becomes the proof copy. Accordingly, the four jobs stored in the private spooler are outputted one by one. Incidentally, the four jobs are stored in the private spooler as they are. Besides, when the card is in the range of the electric wave until 8 seconds have passed, and then is moved to the outside of the electric wave, that is, when the beep sound is generated four times, the process of the private print job becomes the deletion of all documents. Accordingly, all the jobs in the private spooler are deleted. Besides, the card is in the range of the electric wave for 8 seconds or more and is then moved to the outside of the electric wave, that is, when the beep sound is generated five times, the processing of the private print job becomes such that the processing (namely, operation) is cancelled. Accordingly, the four jobs in the private spooler are not printed. Besides, the four jobs are stored in the private spooler as they are.

According to the image forming apparatus 1 of this embodiment, the following effects can be obtained. When the user keeps his/her own card in the range of the electric wave emitted from the authentication device 20, the beep sound is generated each time the specified time has passed. Based on the number of times of generation of the beep sound and the third table 19c in which the processing setting of the private print job is previously performed, the user can cause the private print job stored in the spooler in the image forming apparatus 1 to be processed in a desired processing format. Accordingly, in the image forming apparatus 1, when the processing of the private print job is performed, the processing format can be changed after the authentication without performing extra manual input using the control panel 18 or the like.

Incidentally, in the embodiment, although the setting of the processing of the private print job is made in the third table 19c correspondingly to the specified time, instead of this, the following may be adopted. That is, the setting of the third table 19c is made such that the setting of the processing of the private print job is made correspondingly to the number of times of generation of the beep sound, and a counter provided in, for example, the RAM 13 is incremented when the beep sound is generated at intervals of a specified time. Then, a processing corresponding to the final count value of the counter is performed. Also in such a manner, similar effects can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a first storage part configured to correlate first identification information set for a user allowed to use with second identification information of the user used in a network and to store them;
a reception part configured to receive a private print job including the second identification information and information indicating print content through the network;
an accumulation part configured to accumulate, for each piece of the second identification information, the private print job received in the reception part based on the information stored in the first storage part;
a second storage part configured to store different processings for the accumulated private print jobs at intervals of previously set times and for each piece of the first identification information;
a clock part configured to count a time;
an authentication part configured to use the first identification information and to authenticate that the user is allowed to use; and
a control part configured to use the clock part to count a time in which the authentication has been continuously performed since a time when the authentication was performed in the authentication part, and to perform a processing, which corresponds to the counted time and the first identification information used in the authentication and is stored in the second storage part, for the private print job accumulated in the accumulation part and corresponding to the first identification information.

2. The image forming apparatus according to claim 1, further comprising a sound generation part configured to generate a sound at the intervals of the previously set times.

3. The image forming apparatus according to claim 2, further comprising:
a third storage part configured to store a message indicating processing content of the private print job; and
a display part configured to display the message corresponding to the counted time and stored in the third storage part.

4. The image forming apparatus according to claim 3, wherein the previously set times are equal to each other.

5. The image forming apparatus according to claim 3, wherein the previously set times are different from each other.

6. The image forming apparatus according to claim 5, wherein the previously set times become long as time passes since the start of the authentication in the authentication part.

7. The image forming apparatus according to claim 3, wherein the display part displays, together with the message, a message for confirmation as to whether the processing indicated by the message is executed.

8. The image forming apparatus according to claim 3, wherein the authentication part reads information stored in an ID card in a non-contact manner, and performs the authentication according to whether the read information coincides with the first identification information stored in the first storage part.

9. The image forming apparatus according to claim 3, wherein the different processings for the private print jobs at intervals of the previously set times are different for each piece of the first identification information.

10. An image forming apparatus comprising:
first storage means for correlating first identification information set for a user allowed to use with second identification information of the user used in a network and for storing them;
reception means for receiving a private print job including the second identification information and information indicating print content through the network;
accumulation means for accumulating, for each piece of the second identification information, the private print job received in the reception means based on the information stored in the first storage means;
second storage means for storing different processings for the accumulated private print jobs at intervals of previously set times and for each piece of the first identification information;
clock means for counting a time;
authentication means for using the first identification information and for authenticating that the user is allowed to use; and
control means for using the clock means to count a time in which the authentication has been continuously performed since a time when the authentication was performed in the authentication means, and for performing a processing, which corresponds to the counted time and the first identification information used in the authentication and is stored in the second storage means, for the private print job accumulated in the accumulation means and corresponding to the first identification information.

11. The image forming apparatus according to claim 10, further comprising sound generation means for generating a sound at the intervals of the previously set times.

12. The image forming apparatus according to claim 11, further comprising:
third storage means for storing a message indicating processing content of the private print job; and
display means for displaying the message corresponding to the counted time and stored in the third storage means.

13. A processing method of a private print job of an image forming apparatus comprising a first storage part configured to correlate first identification information set for a user allowed to use with second identification information of the user used in a network and to store them, a reception part configured to receive a private print job including the second identification information and information indicating print content through the network, an accumulation part configured to accumulate, for each piece of the second identification information, the private print job received in the reception part based on the information stored in the first storage part, and a second storage part configured to store different processings for the accumulated private print jobs at intervals of previously set times and for each piece of the first identification information, the method comprising:
using the first identification information to authenticate that the user is allowed to use;
counting a time in which the authentication has been continuously performed since the authentication was performed; and
performing a processing, which corresponds to the counted time and the first identification information used in the authentication and is stored in the second storage part, for the private print job accumulated in the accumulation part and corresponding to the first identification information.

14. The method according to claim 13, further comprising:
generating a sound at the intervals of the previously set times.

15. The method according to claim 14, further comprising:
displaying a message corresponding to the counted time and indicating processing content of the private print job.

16. The method according to claim 15, wherein the previously set times are equal to each other.

17. The method according to claim 15, wherein the previously set times are different from each other.

18. The method according to claim 17, wherein the previously set times become long as time passes since the authentication was started.

19. The method according to claim 15, wherein at the displaying, together with the message, a message for confirmation as to whether the processing indicated by the message is executed is also displayed.

20. The method according to claim 15, wherein at the authenticating, information stored in an ID card is read in a non-contact manner, and a judgment is made as to whether the read information coincides with the first identification information stored in the first storage part.
